(19) United States
(12) Patent Application Publication
(10) Pub. No.: US 2026/0202812 A1
(43) Pub. Date: Jul. 16, 2026

(54) REDUNDANCY MANAGEMENT AND CONTROL OF INDUSTRIAL ASSETS

(71) Applicant: Baker Hughes Holdings LLC, Houston, TX (US)

(72) Inventors: Mark Gneiting, Gardnerville, NV (US); Christopher Grover, Huntsburg, OH (US)

(21) Appl. No.: 19/024,930

(22) Filed: Jan. 16, 2025

(51) Int. Cl. G05B 19/05

(52) U.S. Cl. CPC G05B 19/054; G05B 2219/15032; G05B 2219/15116

(57) ABSTRACT

At a first system switch channel in a redundancy group, data characterizing an operating parameter, a corresponding timestamp, and a corresponding unique instance identifier is received from a second system switch channel in the redundancy group via a network. A previous operating parameter of the first system switch channel is updated to reflect the received operating parameter and the corresponding timestamp upon an execution of an arbitration algorithm. The received timestamp is compared with a locally stored timestamp corresponding to the previous operating parameter. The unique instance identifier associated with the first system switch channel is compared with a unique instance identifier associated with the second system switch channel. A determination is made as to whether to update the previous operating parameter of the first system switch channel with the received operating parameter based on comparing the timestamps and the unique instance identifiers.

### TECHNICAL FIELD

The subject matter described herein relates to the field of industrial automation and control systems.

### BACKGROUND

Industrial systems rely on communication infrastructures to maintain operation of machinery and ensure reliability across interconnected components. The communication infrastructure is responsible for the exchange of data, such as transmitting control and monitoring data, between various components including control systems and field machines. Failure in communication can result in outdated or inaccurate data being used for decision-making, potentially incur significant loss of production, potential injury to workers, and/or environmental hazard.

To address these challenges, systems employ redundancy strategies that aim to minimize the risk of communication failures. Redundancy involves having multiple pathways or systems available to handle the same set of operations, allowing a fallback mechanism in the event of a failure.

### SUMMARY

This disclosure relates to redundancy management and control of industrial assets.

An example implementation of the subject matter described within this disclosure is a method with the following features. At a first system switch channel in a redundancy group, data characterizing an operating parameter, a corresponding timestamp, and a corresponding unique instance identifier is received from a second system switch channel in the redundancy group via a network. A previous operating parameter of the first system switch channel is updated to reflect the received operating parameter and the corresponding timestamp upon an execution of an arbitration algorithm. The arbitration algorithm includes the following operations. The received timestamp is compared with a locally stored timestamp corresponding to the previous operating parameter. The unique instance identifier associated with the first system switch channel is compared with a unique instance identifier associated with the second system switch channel. A determination is made as to whether to update the previous operating parameter of the first system switch channel with the received operating parameter and the corresponding timestamp based on comparing the timestamps and the unique instance identifiers.

The disclosed method can be implemented in a variety of ways. For example, within a system that includes a network and a redundancy group including a first system switch channel and a second system switch channel communicatively connected to each other by the network. Alternatively, or in addition, the method can be used with an industrial asset having an industrial machine interfaced with each one of the system switch channels in the redundancy group. In some implementations, either the first system switch channel or the second system switch channel is configured to perform aspects of the method.

Aspects of the example method, that can be combined with the example method alone or in combination with other aspects, can include the following. Each one of the first switch channel and the second system switch channel is subscribed to one another by the network.

Aspects of the example method, that can be combined with the example method alone or in combination with other aspects, can include the following. A status or a condition of an industrial machine interfaced with the second system switch channel is received. The industrial machine is communicatively connected to the network.

Aspects of the example method, that can be combined with the example method alone or in combination with other aspects, can include the following. The operating parameter includes an alarm control.

Aspects of the example method, that can be combined with the example method alone or in combination with other aspects, can include the following. Each unique instance identifier is assigned sequentially to the system switch channels in the redundancy group.

Aspects of the example method, that can be combined with the example method alone or in combination with other aspects, can include the following. The previous operating parameter of the first system switch channel is updated upon the execution of the arbitration algorithm, when the received timestamp is more recent than the locally stored timestamp.

Aspects of the example method, that can be combined with the example method alone or in combination with other aspects, can include the following. In an event that the received timestamp and the locally stored timestamp are identical, the previous operating parameter of the first system switch channel is updated when the unique instance identifier associated with the second system switch channel is lower than the unique instance identifier associated with the first system switch channel.

Aspects of the example method, that can be combined with the example method alone or in combination with other aspects, can include the following. The arbitrated operating parameter is stored in a Modbus register interfaced with the first system switch channel.

Aspects of the example method, that can be combined with the example method alone or in combination with other aspects, can include the following. The updated operating parameter is provided to the network for use by a third system switch channel in the redundancy group.

### BRIEF DESCRIPTION OF DRAWINGS

These and other features will be more readily understood from the following detailed description taken in conjunction with the accompanying drawings.

FIG. 1 is a flowchart of an example method that can be used with aspects of this disclosure;

FIG. 2 is a flowchart of an example arbitration algorithm; and

FIG. 3 is a block diagram of an example system that can be used with aspects of this disclosure.

### DETAILED DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

In mission-critical systems, such as those used in industrial automation/control, energy production, and manufacturing processes, reliable and fault-tolerant communication is needed to ensure the continuous and safe operation of the machines. A failure in communication can lead to operational disruptions, safety hazards, and financial losses. To mitigate these risks, redundant system switch channels are employed. However, managing these redundancy groups presents significant challenges, particularly in ensuring that the most recent and accurate data is propagated while avoiding inconsistencies or conflicts between redundant channels. Data inconsistencies may occur when two or more systems switch channels attempt to update the same operating parameter simultaneously, particularly if there is no mechanism to determine which update should take precedence. Additionally, relying on centralized coordination modules for managing redundancy introduces single points of failure, which compromise the reliability of the overall system.

This disclosure relates to managing redundancy within a group of system switch channels that are interconnected via a network. The method enables a resolution of conflicts between redundant system switch channels through an arbitration algorithm. Specifically, the method and the system described herein allow each system switch channel to receive data characterizing an operating parameter, along with a corresponding timestamp and a unique instance identifier, from another system switch channel in the redundancy group, and update locally stored values independently, based on comparing the received timestamp and unique instance identifier with the locally stored values, to the received operating parameter and the corresponding timestamp without using a centralized coordination module.

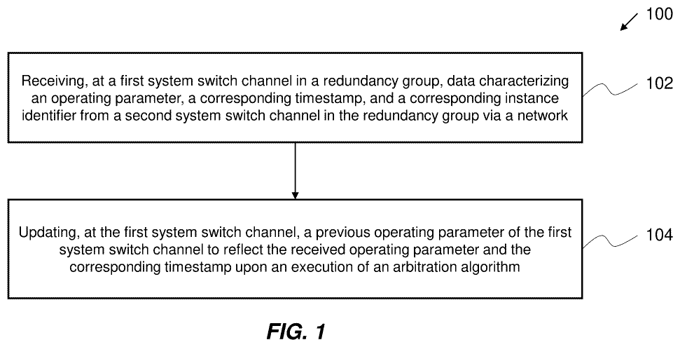

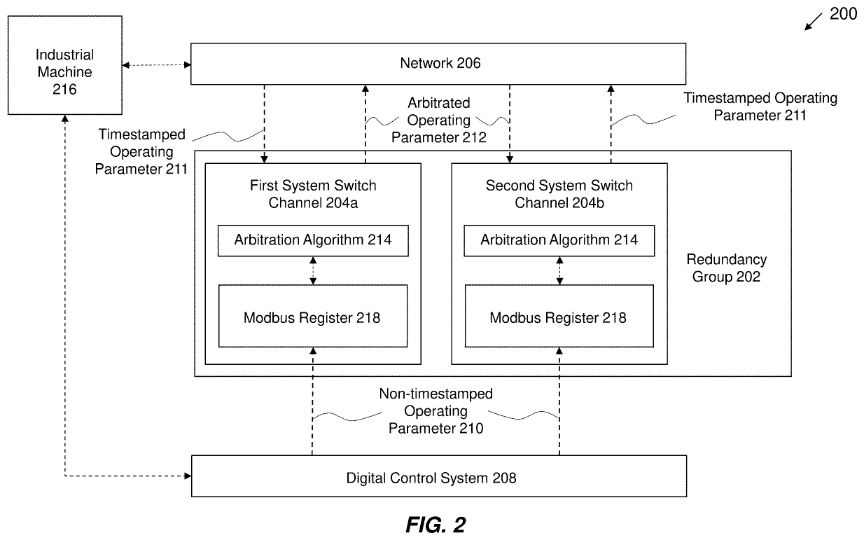

FIG. 1 is a flow chart of an example method 100 that can be used with aspects of this disclosure. At 102, data characterizing an operating parameter, a corresponding timestamp, and a corresponding unique instance identifier is received at a first system switch channel in a redundancy group from a second system switch channel in the redundancy group via a network. A system switch channel is a communication interface responsible for transmitting, receiving, and processing data related to the operation of an industrial control or monitoring system. In some implementations, the system switch channel acts as an interface between the industrial asset, such as an industrial machine as shown in FIG. 2 below, and a higher-level control system. Each system switch channel is configured to handle specific control, for example, alarm signals, and ensure that such signals are shared and synchronized with other system switch channels in the same redundancy group.

FIG. 2 is a block diagram of an example system 200 that can implement the example method 100. The system 200 includes a redundancy group 202 including a first system switch channel 204a and a second system switch channel 204b, interconnected via a network 206 and communicatively linked to a digital control system 208. The redundancy group 202 refers to a collection of interconnected system switch channels that, according to some implementations, collectively work to provide fault tolerance within a networked system so that even if one or more channels fail, the system 200 continues to operate without interruption. The redundancy group 202 can include 1 to N system switch channels that are subscribed to one another via the network 206. Each channel has references to its redundant counterparts within the same redundancy group. For example, each system switch channel has N-1 references. These references allow the system switch channels to identify and subscribe to the data produced by their redundant counterparts. In some cases, references can be stored within the metadata of the system switch channel object. For instance, a pointer or a link from the first system switch channel 204a to another redundant system switch channel e.g., the second system switch channel 204b in the redundancy group 202 may be associated with the first system switch channel 204a through a designated attribute.

In some implementations, the network 206 includes one or more physical or logical infrastructures that interconnect system switch channels across multiple redundancy groups. The network 206 can be a wired or wireless communication system that supports any data transmission protocols suitable for the system 200. For example, the network 206 can be implemented as a proprietary TCP/IP-based information network that supports one or more redundancy groups. One or more standardized industrial communication protocols can be implemented to facilitate data exchange between system switch channels. Alternatively, the network 206 may include a cloud-based network or shared data bus architecture where all system switch channels can access and write to a common data repository or bus for exchanging operating parameters. Further, the first system switch channel 204a and the second system switch channel 204b may directly communicate to each other via a local network topology, such as a mesh network that non-hierarchically connects both system switch channels in a peer-to-peer configuration.

In some instances, the digital control system 208 is configured to monitor and control operations of the system 200. Each system switch channel is configured to manage, process, and arbitrate operating parameters 210, 211, 212 exchanged between system switch channels and communicated to the digital control system 208. In some cases, specific data value or status that characterizes an operational state, condition, or otherwise behavior of a system or a machine within a controlled industrial environment is exchanged between the first system switch channel 204a and the second system switch channel 204b in the redundancy group 202. In some implementations, operating parameters 210, 211, 212 includes system conditions, inputs/outputs, external commands, or other dynamic values that may change over time in response to these parameters. Examples of operating parameters 210, 211, 212 include a status indicator (e.g., ON/OFF states and operational mode), control values (e.g., values signaling a fault or warning condition), measurement values (e.g., sensor readings such as temperature, pressure, flow velocity, and voltage), and control commands (e.g., set values).

For example, the non-timestamped operating parameter 210 received from the digital control system 208 may indicate whether a specific condition or threshold has been exceeded, requiring action or notification. The second system switch channel 204b may receive an alarm control signal from the connected digital control system 208 when a monitored condition, such as temperature or pressure measured from a controlled industrial machine exceeds a predefined limit. This alarm control signal may be transmitted to other system switch channels e.g., the first system switch channel 204a, and a third system switch channel (not shown) in the redundancy group 202.

The system 200 can be integrated into an industrial asset. Industrial assets can include an industrial machine 216, such as, without limitation, a turbine, a compressor, a pump, a generator, a robotic arm, and any other mechanical equipment used in the industries that require control and monitoring for operation. In some implementations, the first system switch channel 204a can receive a timestamped operating parameter 211, such as a status or a condition of an industrial machine, along with the unique instance identifier associated with the second system switch channel 204b, from the network 206 interfaced with the industrial machine 216. The industrial machine 216 is also communicatively coupled to the digital control system 208 which manages the operations of the industrial asset. In some instances, the digital control system 208 can provide control values such as alarm inhibit or mode control, and receive feedback from the industrial machine 216. The redundancy group 202 provides a layer of redundancy and fault tolerance for the communication and control of the industrial machine 216. Operating parameter 210 can be received from the industrial machine 216 through the digital control system 208.

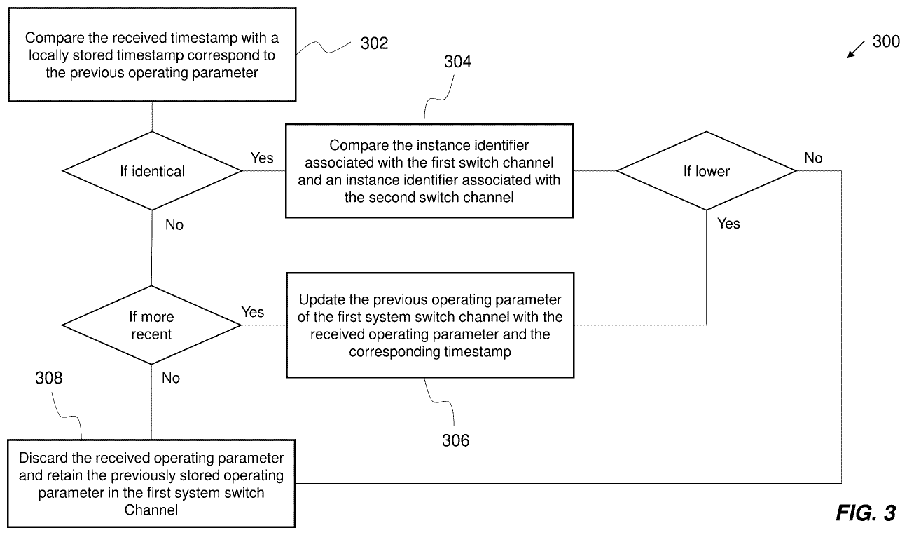

Each one of the first system switch channel 204a and the second system switch channel 204b includes an arbitration algorithm 214. The arbitration algorithm 214 is implemented to process and validate the timestamped operating parameters 211 received, via the network 206, from other system switch channels in the redundancy group 202. The arbitration algorithm 214 is described in further detail with reference to FIG. 3 later within this disclosure. In some implementations, each one of the first system switch channel 204a and the second system switch channel 204b includes a Modbus register 218 configured to store the arbitrated operating parameter 212. The arbitrated operating parameter 212 is published to the network 206 and received by other subscribed system switch channels in the redundancy group 202.

Modbus registers 218 are 16-bit memory locations that can store numeric values ranging from 0 to 65,535 (unsigned integer) or −32,768 to 32,767 (signed integer) depending on the specific system implementation. The Modbus registers can be grouped for storing larger values or more complex data types (e.g., a 32-bit floating-point value or timestamps). In some instances, Modbus registers 218 are interfaced with the system switch channels, acting as repositories for storing operating parameters 210, 211, 212 and the corresponding metadata. Each one of the first system switch channel 204a and the second system switch channel 204b has its own set of Modbus registers. For example, each one of the first system switch channel 204a and the second system switch channel 204b writes its most up-to-date operating parameters to its associated Modbus register 218 through defined function codes (“06” for write single holding register or “16” for write multiple holding registers). Similarly, these operating parameters can be retrieved by a functional module configured to execute the arbitration algorithm 214 in case of simultaneous update through defined function code (e.g., “03” for read holding registers). Additionally, Modbus registers 218 may be integrated with programmable logic controllers (PLCs), human-machine interfaces (HMIs), and supervisory control and data acquisition (SCADA) systems. It should be noted that updates coming from the arbitration algorithm are now required to follow such Modbus protocol as they have direct access to the Modbus register itself and can update stored values directly as needed.

In some instances, the timestamp is generated at the time the non-timestamped operating parameter 210 is received by a system switch channel. For example, the timestamp records the exact system time when an alarm control object is generated, which happens after the operating parameter (e.g., control value) has been written to the Modbus register 218. In some implementations, the timestamp is embedded into the data payload or metadata of the timestamped operating parameter 211 as it is transmitted across the network 206. Timestamping of arbitrated operating parameters 212 is only done when the operating parameter that was written to the Modbus register 218 is processed by the arbitration algorithm 214 and the previous operating parameter in the system switch channel is updated.

For example, a non-timestamped operating parameter such as a temperature reading of 75° C. from an industrial machine can be assigned a timestamp originates from a synchronized, trusted system clock implemented within the network or individual system switch channels. The system clock may leverage standard time protocols, such as the Network Time Protocol (NTP). The timestamp may be in a specific timestamp format, such as ISO 8601 (“yyyy-MM-ddTHH:mm: ss.SSSTZD”) or Unix Epoch.

The unique instance identifier can be a unique value assigned to each system switch channel in the redundancy group 202. The assignment can be at the time of, system 200 initialization, reconfiguration of the redundancy group 202 (e.g., system switch channel inclusion/exclusion), industrial machine recovery or restart, network 206 re-synchronization, and/or receipt of user input. In some instances, the unique instance identifier is implemented to distinguish between system switch channels and is used as a secondary criterion for conflict resolution when timestamps are identical. For example, the unique instance identifiers can be sequentially assigned integers, such as “1”, “2”, “3”. Etc., where the arbitration algorithm 214 is implemented to give priority to the system switch channel with the lower identifier. This is because lower unique instance identifiers are often assigned first. Similarly, the unique instance identifier is included in the data payload or metadata alongside timestamped operating parameter 211 to ensure that other system switch channels in the same redundancy group 202 can access it during the arbitration.

Alternatively or in addition, both the timestamp and the unique instance identifier may be associated with the system switch channel. In this implementation, each one of the first system switch channel 204a and the second system switch channel 204b maintains a single timestamp representing, for example, the most recent time at which it processed, stored, or updated the operating parameter 210, 211, 212. For example, each one of the first system switch channel 204a and the second system switch channel 204b can have a timestamp representing the last time it received, published, or validated the operating parameter 210, 211, 212. When the second system switch channel 204b transmits data to the first system switch channel 204a, a current timestamp of the second system switch channel 204b is included alongside the operating parameter to indicate the recency of the transmission.

Returning to FIG. 1, at 104, a previous operating parameter of the first system switch channel is updated to reflect the received operating parameter and the corresponding timestamp upon an execution of an arbitration algorithm. The previous operating parameter refers to the last known or stored value associated with a specific control or monitoring condition maintained by the first system switch channel. For example, the previous operating parameter represents a previous operating state or historical data point, such as a previous alarm state, control value, or condition of the industrial machine interfaced with the first system switch channel before the latest update is received from the second system switch channel or other system switch channels within the redundancy group. The previous operating parameter is associated with a locally stored timestamp and unique instance identifier which reflects when and from which system switch channel the value was last updated.

FIG. 3 illustrates an exemplary embodiment of the arbitration algorithm 300. The arbitration algorithm 300 is a process executed by the system switch channel to determine whether the received operating parameter should replace the previous operating parameter. In some instances, system switch channel includes a functional module or component that is configured to perform the arbitration process. According to some implementations, the system switch channel can include a software or firmware component that interacts with one or more Modbus registers to process and store arbitrated control values which are then communicated to the network or other system switch channels. The arbitration algorithm 300 includes systematic comparison of timestamps and unique instance identifiers associated with the received operating parameters (302, 304).

The arbitration algorithm 300 includes comparing the received timestamp with the locally stored timestamp associated with the previous operating parameter (302). If the received timestamp is more recent than the stored timestamp, the received operating parameter is deemed more recent and therefore eligible to update (or replace) the previous operating parameter (306), otherwise the received operating parameter is discarded and the previously stored operating parameter in the first system switch channel is retained (308). In scenarios where the received timestamp and the locally stored timestamp are identical (indicating simultaneous updates), the arbitration algorithm 300 resolves the conflict by comparing the unique instance identifiers of the system switch channels (304). The system switch channel with the lower unique instance identifier is given priority during the arbitration process. Once the arbitration algorithm 300 determines that the received operating parameter should be updated, the first system switch channel updates its stored operating parameter to reflect the new value, along with the corresponding timestamp (306). This updated information is then made available for further dissemination across the redundancy group and to other system switch channels via the network. If both unique instance identifiers are identical, or if the unique instance identifier associated with the second system switch channel is higher than the unique instance identifier associated with the first system switch channel, the message (including the received operating parameter, the corresponding timestamp, and the corresponding unique instance identifier) is discarded and the update is aborted (308). The first system switch channel may continue listening for new updates or retain a stable state.

However, in the event of a system reboot, it is possible for the timestamp associated with system switch channel to reset to a default value (e.g., “0”) that is less than timestamps locally stored in the system switch channels. Such a scenario can disrupt the arbitration process as the reset system time will result in incoming updates with “older” timestamps being misinterpreted as more recent. Such inconsistency can lead to incorrect or outdated operating parameters being propagated across the redundancy group, compromising system reliability and safety. In some implementations, upon boot-up, each system switch channel performs a system time validation check involving comparing the current system timestamp to the locally stored timestamps to identify a potential system time reset event and performs a one-time update to the locally stored value to ensure that the timestamps are consistent with the reset system time in response to the identified system time reset event.

Returning to FIG. 1, in some cases, operating parameters can include state mode controls that are not handled the same way as standard controls. Unlike standard switches (e.g., alarm control signal that can often be aggregated at the consumer), mode controls are not combined or aggregated. If any system switch channel sends an alarm control signal (e.g., “fault detected”), the consumer can act on it regardless of which system switch channel sent it. The mode control is not meaningful for the consumer to aggregate multiple mode controls because a system or machine cannot operate in multiple modes simultaneously. This means that only the most recent, valid mode control is actionable. For example, some industrial machines act on the last valid mode control received. These state mode controls may govern transitions between different operational states, such as “startup,” “shutdown,” or “maintenance,” which directly affect the configuration and behavior of the industrial machines. Mode controls can be initiated by one or more system switch channels in the redundancy group based on inputs received from external systems, such as the digital control system, or from operator commands (e.g., user inputs). In some instances, the digital control system can issue a mode control update when it detects a change in operational conditions, for example, a fault requiring a transition to “emergency stop” mode, or when an operator manually initiates the “maintenance” mode.

Certain exemplary implementations will now be described to provide an overall understanding of the principles of the structure, function, manufacture, and use of the systems, devices, and methods disclosed herein. One or more examples of these implementations are illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, subprograms, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a Read-only Memory or a Random Access Memory or both. The essential elements of a computer are a processor for executing instructions and one or more memory devices for storing instructions and data. Generally, a computer will also include or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magnetooptical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a backend component (e.g., a data server), a middleware component (e.g., an application server), or a frontend component (e.g., a client computer having a graphical user interface or a web interface through which a user can interact with an implementation of the subject matter described herein), or any combination of such backend, middleware, and frontend components. The system's components can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving, at a first system switch channel in a redundancy group, data characterizing an operating parameter, a corresponding timestamp, and a corresponding unique instance identifier from a second system switch channel in the redundancy group via a network
updating, at the first system switch channel, a previous operating parameter of the first system switch channel to reflect the received operating parameter, the corresponding timestamp upon an execution of an arbitration algorithm, wherein the arbitration algorithm comprises:
comparing the received timestamp with a locally stored timestamp correspond to the previous operating parameter;
comparing the unique instance identifier associated with the first system switch channel and a unique instance identifier associated with the second system switch channel; and
determining, based on comparing the timestamps and the unique instance identifiers, whether to update the previous operating parameter of the first system switch channel with the received operating parameter and the corresponding timestamp.

2. The method of claim 1, further comprising:
subscribing, the first system switch channel and the second system switch channel to one another by the network.

3. The method of claim 1, wherein receiving the operating parameter comprises:
receiving a status or a condition of an industrial machine interfaced with the second system switch channel, wherein the industrial machine is communicatively connected to the network.

4. The method of claim 3, wherein the operating parameter comprises an alarm control.

5. The method of claim 1, further comprising:
assigning each unique instance identifier sequentially to the system switch channels in the redundancy group.

6. The method of claim 1, wherein updating the previous operating parameter of the first system switch channel comprises:
updating the previous operating parameter of the first system switch channel when the received timestamp is more recent than the locally stored timestamp upon the execution of the arbitration algorithm.

7. The method of claim 6, wherein the received timestamp and the locally stored timestamp are identical, wherein updating the previous operating parameter of the first system switch channel comprises:
updating the previous operating parameter of the first system switch channel when the unique instance identifier associated with the second system switch channel is lower than the unique instance identifier associated with the first system switch channel.

8. The method of claim 7, wherein updating the previous operating parameter of the first system switch channel comprises:
storing the arbitrated operating parameter in a Modbus register interfaced with the first system switch channel.

9. The method of claim 1, further comprising:
providing the updated operating parameter to the network for use by a third system switch channel in the redundancy group.

10. A system comprising:
a network;
a redundancy group comprises a first system switch channel and a second system switch channel communicatively connected to the first system switch channel by the network, wherein the first system switch channel is configured to:
receive data characterizing an operating parameter, a corresponding timestamp, and a corresponding unique instance identifier from the second system switch channel in the redundancy group via the network;
update a previous operating parameter of the first system switch channel to reflect the received operating parameter and the corresponding timestamp upon an execution of an arbitration algorithm, wherein the arbitration algorithm comprises:
comparing the received timestamp with a locally stored timestamp correspond to the previous operating parameter;
comparing the unique instance identifier associated with the first system switch channel and a unique instance identifier associated with the second system switch channel; and
determining, based on the comparing the timestamps and the unique instance identifiers, whether to update the previous operating parameter of the first system switch channel with the received operating parameter and the corresponding timestamp.

11. The system of claim 10, wherein the first system switch channel and the second system switch channel are configured to subscribe to one another by the network.

12. The system of claim 10, wherein the operating parameter corresponds to a status or a condition of an industrial machine interfaced with the second system switch channel, wherein the industrial machine is communicatively connected to the network.

13. The system of claim 12, wherein the operating parameter comprises an alarm control.

14. The system of claim 10, wherein each unique instance identifier is assigned sequentially to the system switch channels in the redundancy group.

15. The system of claim 10, wherein updating the previous operating parameter of the first system switch channel comprises:
updating the previous operating parameter of the first system switch channel when the received timestamp is more recent than the locally stored timestamp upon the execution of the arbitration algorithm.

16. The system of claim 15, wherein the received timestamp and the locally stored timestamp are identical, wherein updating the previous operating parameter of the first system switch channel comprises:
updating the previous operating parameter of the first system switch channel when the unique instance identifier associated with the second system switch channel is lower than the unique instance identifier associated with the first system switch channel.

17. The system of claim 16, further comprises:
a Modbus register interfaced with the first system switch channel, wherein the Modbus register is configured to store the arbitrated operating parameter.

18. An industrial asset comprising:
an industrial machine;
a network;
a redundancy group comprises a first system switch channel and a second system switch channel communicatively connected to the first system switch channel via the network sharing interface, each one of the first system switch channel and the second system switch channel is interfaced with the industrial machine, wherein the first system switch channel is configured to:
receive data characterizing an operating parameter, a corresponding timestamp, and a corresponding unique instance identifier from the second system switch channel in the redundancy group via a network;
update a previous operating parameter of the first system switch channel to reflect the received operating parameter and the corresponding timestamp upon an execution of an arbitration algorithm, wherein the arbitration algorithm comprises:
comparing the received timestamp with a locally stored timestamp correspond to the previous operating parameter;
comparing the unique instance identifier associated with the first system switch channel and a unique instance identifier associated with the system second switch channel; and
determining, based on comparing the timestamps and the unique instance identifiers, whether to update the previous operating parameter of the first system switch channel with the received operating parameter and the corresponding timestamp.
